(19) United States
(12) Patent Application Publication
(10) Pub. No.: US 2023/0054789 A1
(43) Pub. Date: Feb. 23, 2023

(54) SERVICEABLE BATTERY PACK

(71) Applicant: BRIGGS & STRATTON, LLC, Wauwatosa, WI (US)

(72) Inventors: Jeffrey Zeiler, Pewaukee, WI (US); Michael Marshall, Wauwatosa, WI (US); Jacob Schmalz, Milwaukee, WI (US); John Piechowski, Jackson, WI (US)

(73) Assignee: BRIGGS & STRATTON, LLC, Wauwatosa, WI (US)

(21) Appl. No.: 17/795,977

(22) PCT Filed: Jan. 28, 2021
(86) PCT No.: PCT/IB2021/050686

§ 371 Date: Jul. 28, 2022

Related U.S. Application Data
(60) Provisional application No. 62/968,729, filed on Jan. 31, 2020.

(51) Int. Cl. H01M 50/296; H01M 50/213; H01M 50/262; H01M 10/42; H01M 50/574; H01M 50/271; H01M 50/258

(52) U.S. Cl. CPC H01M 50/296; H01M 50/213; H01M 50/262; H01M 10/425; H01M 50/574; H01M 50/271; H01M 50/258; H01M 2010/4271; H01M 2010/4278

(57) ABSTRACT

A battery pack includes a housing, a positive terminal and a negative terminal, and a plurality of cell module assemblies. The positive terminal and negative terminal are each externally accessible from the housing and extend into a first compartment of the housing. The cell module assemblies are received in a second compartment of the housing, and are coupled to the positive terminal and the negative terminal through a connection extending from the second compartment into the first compartment. The first compartment is accessible through a first panel that is movably coupled to the housing through a first securing mechanism providing a first level of access. The second compartment is accessible through a second panel that is movably coupled to the housing through a second securing mechanism providing a second level of access.

### CROSS-REFERENCE TO RELATED APPLICATION

This application claims priority to U.S. Provisional Patent Application No. 62/968,729, filed Jan. 31, 2020, the content of which is hereby incorporated by reference in its entirety.

### BACKGROUND

Battery packs may be used with different types of equipment, including outdoor power equipment, vehicles, aerial man lifts, floor care devices, golf carts, lift trucks and other industrial vehicles, floor care devices, recreational utility vehicles, industrial utility vehicles, lawn and garden equipment, energy storage or battery backup systems, and other electric vehicles. Outdoor power equipment includes lawn mowers, riding tractors, snow throwers, pressure washers, generators, tillers, log splitters, zero-turn radius mowers, walk-behind mowers, riding mowers, pavement surface preparation devices, industrial vehicles such as forklifts, utility vehicles, commercial turf equipment such as blowers, vacuums, debris loaders, overseeders, power rakes, aerators, sod cutters, brush mowers, sprayers, spreaders, etc. Outdoor power equipment may, for example, use one or more electric motors to drive an implement, such as a rotary blade of a lawn mower, a pump of a pressure washer, the auger of a snow thrower, the alternator of a generator, and/or a drivetrain of the outdoor power equipment. An electric vehicle may also be other types of vehicles such as cars, trucks, automobiles, motorcycles, scooters, boats, all-terrain vehicles (ATVs), personal water craft, snowmobiles, utility vehicles (UTVs), other off-road vehicles (ORVs) and the like.

### SUMMARY

One exemplary embodiment relates to a battery pack. The battery pack includes a housing, a positive terminal, a negative terminal, and cell module assemblies (CMAs). The housing includes a first compartment and a second compartment. The positive terminal and the negative terminal are each externally accessible from the housing and extend into the first compartment. The CMAs are received within the second compartment, and are electrically coupled to the positive terminal and the negative terminal through a connection extending from the second compartment into the first compartment. The CMAs each include a plurality of rechargeable lithium-ion battery cells. The first compartment is accessible through a first panel that is movable coupled to the housing through a first securing mechanism providing a first level of access. The second compartment is accessible through a second panel that is movable coupled to the housing through a second securing mechanism providing a second level of access. The second securing mechanism is different from the first securing mechanism, and includes a lock.

Another exemplary embodiment relates to a battery pack. The battery pack includes a housing, a positive terminal, a negative terminal, and CMAs. The housing includes a first compartment and a second compartment. The positive terminal and the negative terminal are each externally accessible from the housing and extend into the first compartment. The CMAs are received within the second compartment, and are electrically coupled to the positive terminal and the negative terminal through a connection extending from the second compartment into the first compartment. The CMAs each include a plurality of rechargeable lithium-ion battery cells. The first compartment is accessible through a first panel that is movable coupled to the housing through a first securing mechanism providing a first level of access. The second compartment is accessible through a second panel that is movably coupled to the housing through a second securing mechanism providing a second level of access. The second level of access is lower (e.g., less accessible) than the first level of access.

Another exemplary embodiment relates to a battery pack. The battery pack includes a housing, a positive terminal, a negative terminal, a data connector terminal, and CMAs. The positive terminal, negative terminal, and data connector terminal are each externally accessible from the housing and extend into the first compartment. The CMAs are received within the second compartment, and are electrically coupled to the positive terminal and the negative terminal through a physical connection extending from the second compartment into the first compartment. The CMAs each include a plurality of rechargeable lithium-ion battery cells. A battery management system is positioned within the housing and is coupled to the data connector terminal. The battery management system is configured to communicate externally through the data connector terminal (e.g., to provide performance data, operational parameters, etc. from the CMAs to an external device). The first compartment is accessible through a first securing mechanism providing a first level of access. The second compartment is accessible through a second securing mechanism providing a second level of access. The second level of access is lower (e.g., more difficult to access) than the first level of access.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures.

FIG. 1 is a top perspective view of a housing for a battery pack, according to an exemplary embodiment.

FIG. 2 is a perspective view of a battery pack of cell module assemblies with the housing of FIG. 1 removed, according to an exemplary embodiment.

FIG. 3 is a top view of the battery pack of FIG. 2, according to an exemplary embodiment.

FIG. 4 is a bottom view of the battery pack of FIG. 2, according to an exemplary embodiment.

FIG. 5 is a rear view of the battery pack of FIG. 2, according to an exemplary embodiment.

FIG. 6 is a front view of the battery pack of FIG. 2, according to an exemplary embodiment.

FIG. 7 is a left side view of the battery pack of FIG. 2, according to an exemplary embodiment.

FIG. 8 is a block diagram of the battery pack of FIG. 2 showing serviceability compartments.

FIG. 9 is a block diagram of the battery pack of FIG. 2 showing serviceability compartments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

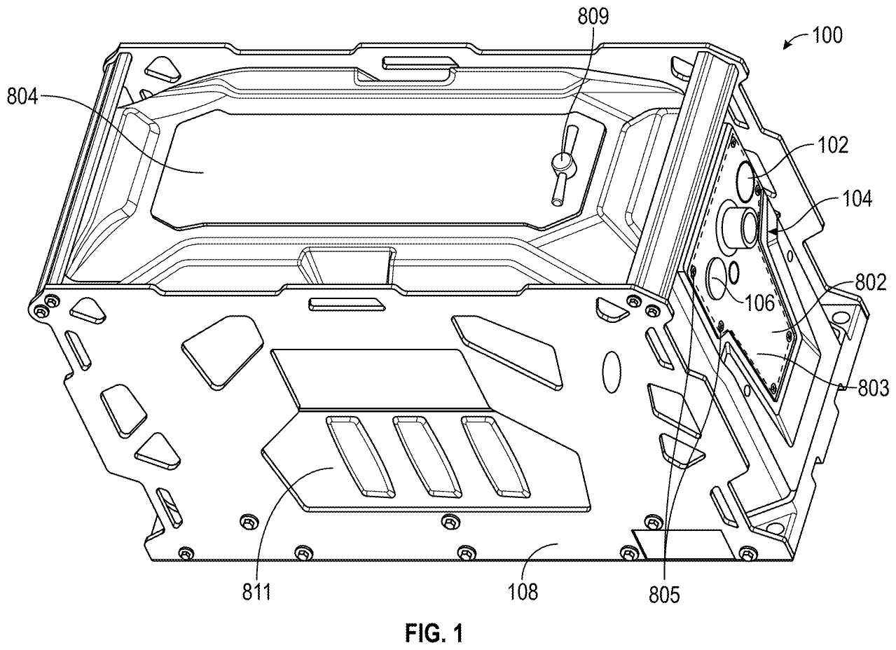

Referring to FIG. 1, a top perspective view of a battery pack 100 with a housing 108 is illustrated, according to an exemplary embodiment. The housing 108 is an exterior enclosure for housing the internal components of a battery pack 100. In some embodiments, the housing 108 is a battery pack case includes one or more removable or movable components that can permit easy access to the battery pack 100 inside. The housing 108 includes a negative terminal 102, a pass-through, panel-mounted data connector or data terminal 104, and a positive terminal 106. The pass-through data connector 104 is positioned between the two terminals 102 and 106. In other embodiments, the pass-through data connector 104 is positioned elsewhere on the front panel of the battery pack 100. In some embodiments, the housing 108 is a single five-sided enclosure that covers the battery pack 100, and sits upon a bottom base plate. In some embodiments, the five sides of the housing 108 are made out of a polymeric material. In some embodiments, the internal cavity of the housing 108 is regulated by an internal circulating fan to create a uniform internal environment. In some embodiments, when the battery pack 100 is assembled, the battery pack 100 is set on a bottom plate of the exterior housing and the five-sided plastic enclosure covers and seals the battery pack 100 to prevent water or debris from getting inside the battery pack 100. The housing 108 can be adaptable for a different size and capacity of the assembled battery pack 100. The housing 108 of the battery pack 100 includes a user interface with an electrically isolated front panel. The panel-mounted data connection terminal 104 of the battery pack 100 may provide protection for short-circuiting the terminals 102, 106 of the battery pack 100. The pass-through data connector 104 may also include poka-yoked pins for controlling different current capacities in the single connector. In some embodiments, the poka-yoked pins prevent the coupling of incorrect components to the pass-through data connector 104.

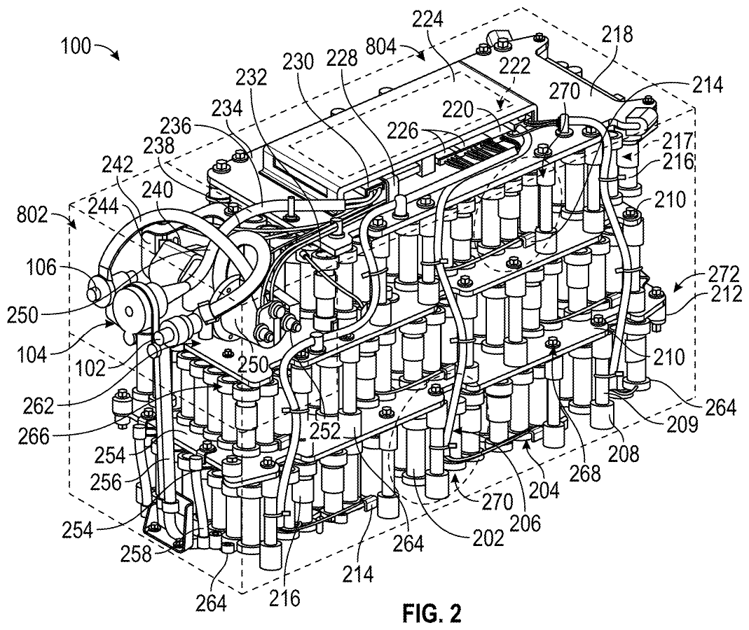

Referring to FIG. 2, a perspective view of the battery pack 100 is shown, according to an exemplary embodiment. The battery pack 100 is shown to include a top plate 218, midplates 210, anti-rack plate 234, spacers 209, harness cutouts 206, and mounting hardware 268. In some embodiments, the top plate 218 and the midplates 210 between the top plate 218 and a base plate at the bottom of the battery pack 100 are made out of aluminum. Each plate may contain several harness cutouts 206 to provide assistance in the routing of the cables throughout the battery pack 100. The harness cutouts 206 may be used to retain the wire harnesses of the battery pack 100. Further, the harness cutouts 206 in the plates of the battery pack 100 allow wires to run between tiers without the expansion of the form factor of battery pack 100. The battery pack 100 may be constructed using lip seals with tie down rails and latches.

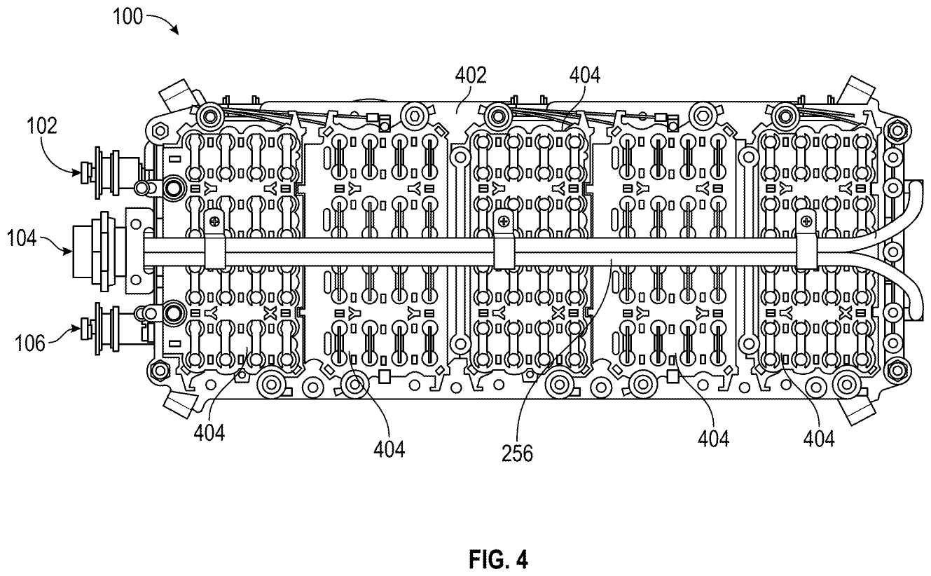

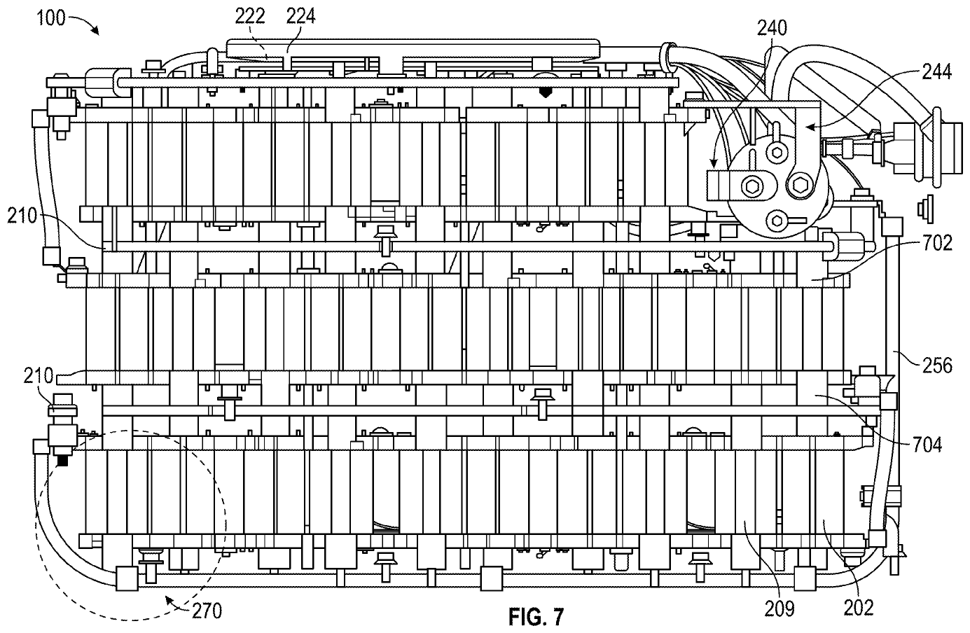

The battery pack 100 may include multiple cell module assemblies (CMAs) 270 vertically positioned in tiers, where a first tier of CMAs 270 is positioned directly above a second tier of CMAs 270. Each CMA 270 includes a top CMA cell holder frame (e.g., top CMA cell holder frame 702 (FIG. 7)), a bottom CMA cell holder frame (e.g., bottom CMA cell holder frame 704 (FIG. 7)), a top collector plate (e.g., positive collector plate 266), a bottom collector plate (e.g., negative collector plate 254), multiple battery cells 202, and curable adhesive to couple the battery cells 202 to the top of the CMA cell holder frame and the bottom CMA cell holder frame. The components included in the CMAs 270 are shown and described in greater detail below with respect to FIGS. 4-8. The CMAs 270 may be spaced between the midplates 210, a midplate 210 and a top plate 218, and the bottom midplate 210 and a base plate 402 (FIG. 4) of the battery pack 100. A tier of the battery pack 100 may include two midplates 210 and several CMAs 270. In some embodiments, the midplates 210 are positioned between the positive terminals of the battery cells 202 of the CMAs 270 within the battery pack 100.

In some embodiments, the battery pack 100 is assembled such that there are gaps between the battery cells of each CMA 270 and a plate. These gaps between the battery cells 202 of the CMAs 270 and the plates in each tier of the battery pack 100 may prevent damage to the battery pack 100 during thermal events. For example, the gaps between the cells of the CMAs 270 and the plates (e.g., top plate 218, midplates 210) allow ejected material from a bad battery cell to build up above the bad battery cell instead of the material extending sideways to the other battery cells 202 in the CMA. Beneficially, when heat is dissipated from the bad battery cell, the likelihood of the thermal event cascading to the other battery cells 202 and causing more damage to the components of the battery pack 100 is reduced. A catastrophic chain reaction from one bad battery cell igniting neighboring battery cells (e.g., battery cells above or below a run-away battery cell) and propagating through short circuit to other battery cells 202 is a potential source of failure. As such, the plates between the positive side of battery cells 202 in the CMAs 270 and the adjacent plates help prevent run-away battery cells from propagating the run-away event and potentially leading to the failure of battery pack 100.

Each of the plates in the battery pack 100 can be electrically isolated to allow each tier of the battery pack 100 to be disconnected while servicing an individual CMA 270 of the battery pack 100. In some embodiments, each CMA 270 of the battery pack 100 can be replaced with removable fasteners and common service tools, such as wrenches and screwdrivers. In some embodiments, each tier of the battery pack 100 is electrically disconnected from the rest of the battery pack 100 until the final assembly of the battery pack is completed and the end wires are connected. The ability to isolate a CMA 270 requiring service due to one or more bad battery cells can advantageously improve the health and battery life of the overall battery pack 100.

The mounting hardware 268 may include fasteners that are easily serviceable with tools such as wrenches. In addition to the mounting hardware 268 used throughout the battery pack 100 providing structure and stability for the battery pack 100, the mounting hardware 268 may provide thermal conductivity along all structural components, plates, spacers, etc. of the battery pack 100. The spacers 209 between all of the tiers of the battery pack 100 may include compression limiters 208. The compression limiters 208 may be steel or aluminum and provide a thermally conductive path, while still maintaining electrically independent tiers, through the tiers of the battery pack 100. For example, the compression limiters 208 may route heat throughout the battery pack 100. In some embodiments, each compression limiter 208 of a spacer 209 has a unique serial number.

A thermistor 217 may be coupled to one of the battery cells 202 within a CMA 270 of the battery pack 100. In some embodiments, the thermistor 217 is secured to a battery cell 202 with tape 216. In some embodiments, closed cell foam adhesive is used to mount the thermistors 217 to the battery cells 202. Each CMA 270 within the battery pack 100 includes one thermistor 217 to monitor the temperature of that individual CMA. The battery pack 100 may also include a resistive heating strip on the plates for uniformly heating the battery pack 100. In some embodiments, each tier has a resistive heating strip that runs at a different heating capacity than the heating strips on the other tiers. The heating element's resistance may change based upon its own temperature. For example, the variable resistance of the heating elements may be based on the temperature of the heating element. As such, when a certain area of the battery pack 100 is determined to be at a higher temperature than the rest of the battery pack 100 (e.g., the top tier of the battery pack is near a component of outdoor power equipment that produces a lot of external heat), the resistive heating element near that area may have a lower heating level than other resistive heating elements in the battery pack 100. For example, the top tier of the battery pack 100 may have a resistive heating element at a lower wattage than a resistive heating element on a lower tier, such as the bottom tier of the battery pack 100.

In other embodiments, a tier of the battery pack 100 may include more resistive heating elements than a different tier. In some embodiments, the resistive heating elements may have positive or negative coefficients to increase the capability of the battery pack 100 to be thermally self-regulated. The battery pack 100 may receive external power to run the internal pack heating elements (e.g., the resistive heating strips) from a charger, or another energy source, using the existing, external terminals. As such, the temperature of the battery pack 100 may be increased above a threshold temperature level without any current flowing into or out of the battery pack 100 and the battery cells 202. In some embodiments, an internal circulating fan helps create a uniform internal temperature for the battery pack 100 without exchanging air outside of the housing 108 of the battery pack 100. Advantageously, by creating a more uniform temperature level inside the housing 108, the battery pack 100 may avoid a particular area of the battery pack 100 having a much higher temperature than the other components of the battery pack 100.

Each CMA 270 of the battery pack 100 includes multiple battery cells 202, which can together output power to operate a vehicle or other equipment, such as various outdoor power equipment. In some embodiments, the battery cells 202 are lithium-ion battery cells. The battery cells 202 can be lithium-ion battery cells rated at 3.6 volts and 3 amp-hours, for example. As illustrated, each of the fourteen CMAs 270 include thirty-two battery cells 202 arranged in four rows of eight cells each, which can be seen in greater detail in FIG. 4. The battery cells 202 are electrically connected to one another using conducting wires having terminals coupled (e.g., wire bonded) to each battery cell 202 and a common conductor (e.g., a positive collector plate 266 or negative collector plate 254). In some embodiments, the wire bonds are 20 mils wire between ⅜ to ½ inch to provide a continuous current of 60 Amps (A) per wire bond without fusing. Each CMA 270 can be identified with an individual identifier (e.g., serial number, bar code, etc.) for use by a CMA 270 manufacturer to track, categorize, evaluate, or record information or data about an individual CMA 270. The individual identifier can then be used by the BMS 222 to relay information about which CMAs 270 in the battery pack 100 need servicing.

The battery pack 100 also includes a battery management system (BMS) 222 for regulating the currents and/or voltages involved in the charging and discharging processes in order to ensure that the battery cells 202 are not damaged or otherwise brought to problematic charge states. For example, the BMS 222 may block an electrical current from being delivered to the battery cells 202, or may block a current being drawn from the battery cells 202 based the current and voltage properties of the signal and/or of the CMA 270. The BMS 222 may also implement controls based on a temperature as detected by a temperature sensor (e.g., thermistor 217) and regulate operation of the CMAs 270 based on over temperature or under temperature conditions determined by the detected temperature received. Additionally, the BMS 222 may allow operation with a battery pack having a variable power supply. The battery pack 100 can be connected in series or parallel because of the protected BMS 222 within the battery pack 100. In some embodiments, the same BMS 222 may be used with a battery pack 100 that has a nominal voltage (V) of 24V, 36V, or 48V.

In some embodiments, a dual controller area network (CAN) bus data communication line is included in the battery pack 100 and electrically and communicatively coupled to the BMS 222, enabling vehicle and/or machine functionality. The two baud rates of the dual CAN bus line may allow the battery pack 100 to act as a gateway (e.g., an Internet of Things (IoT) gateway) between the vehicle (e.g., outdoor power equipment) and the dual CAN bus line in the battery. In some embodiments, an IoT gateway is also included in the battery pack 100 (e.g., integrated with the BMS 222), rather than external to the battery pack 100. The dual CAN bus line may implement IoT in the battery pack 100 to use as an IoT module for the vehicle (e.g., outdoor power equipment).

The maximum charge capacity of the battery cells 202 of the CMAs 270 in the battery pack 100 decay over the life of the battery pack 100 as the battery pack 100 ages. This decay is caused by the battery pack 100 being cycled by discharging and then recharging the battery pack 100, changes in temperature (e.g., high temperatures), and degradation of the chemistry of the battery cells 202. A cycle is the transition from the battery pack's fully charged state (as allowed by the BMS 222) to a partially or fully discharged state (as allowed by the BMS 222). As the number of cycles increases over the life of the battery pack 100, the battery pack 100's maximum charge capacity declines.

The BMS 222 of the battery pack 100 may include an integrated data logger and may be programmed to store data related to the operation of the CMAs 270 in a memory of the BMS 222. The information recorded by the BMS 222 may then be used to determine a useful life measurement for each CMA. The useful life measurement may be expressed in terms of a percentage of life (e.g., the CMA 270 is at 100% life when brand new). The useful life measurement may be used to set multiple end of life thresholds tied to certain applications for the CMAs 270. For example, a CMA's first life could extend between 100% and 70% charge capacity where the CMA 270 would be suitable for use powering outdoor power equipment (e.g., a commercial lawn mower). After the end of the first life (e.g., a useful life measurement below 70%), a CMA 270 may be reconditioned and put to use in its second life (e.g., between 70% and 50%), in which the CMA 270 is suitable for use in a battery pack for equipment having lower energy requirements than the equipment powered by the CMA 270 during its first life in battery pack 100. In some embodiments, the programming of the BMS 222 of the battery pack 100 being used in a second life is reset or reconfigured. By resetting the programming of the BMS 222 at the beginning of the battery pack 100's second life, the BMS 222 may show a charge capacity of 100% relative to its new lowered charge capacity. For example, the BMS 222 may include an “odometer” like measurement that is reset such that a 5 kilowatt-hour (kW-hr) battery pack with a charge capacity of 80% is now a 4 kW-hr battery pack with a charge capacity at 100%.

The useful life measurement can be determined by a number of data points indicative of useful life that can be monitored and saved by BMS 222. These useful life indicators include charge capacity, days, or other time elapsed since a commissioning date when each CMA 270 is first put into service, number of cycles since the commissioning date, depth of cycle for individual cycles or groups of cycles, an electrical charge meter that counts the number of coulombs supplied by the CMAs 270 since the commission date, an event counter of operation of the CMAs 270 in extreme temperature conditions (e.g., above 140 degrees Fahrenheit) for individual events or groups of events, the current supplied by the CMAs 270, the current received by the CMAs 270 for charging, the voltage supplied by the CMAs 270, and/or the voltage applied to the CMAs 270 during charging. In other embodiments, different combinations of useful life indicators are monitored and saved by the BMS 222. The useful life indicators identified above may be monitored individually in some embodiments or monitored in any combination in other embodiments. In other embodiments, useful life indicators are tracked and stored for each individual battery cell 202 of each CMA 270 in the battery pack 100 in the integrated memory of the BMS 222.

Gathering and tracking useful life indicators across the life of the CMA 270 rather than a single instantaneous reading indicative of the end of life (e.g., 70% charging capacity) provides additional information to classify a CMA 270 for reconditioning to an appropriate use. In some embodiments, not every data point associated with a useful life indicator is stored, for example temperature may be sampled and stored on a weekly basis rather than daily basis. CMAs 270 may be classified where different classifications are suitable for use in different second lives or based on different expected future performance in the second life as determined by the evaluation of the useful life indicators from the first life. Tracking useful life indicators also provides the CMA 270 manufacturer with data that can be used for diagnostics to determine why a particular CMA 270 performs better or worse than a similar CMA 270 and then use that diagnostic information to improve manufacturing or other processes for new CMAs.

For example, a CMA 270 with 70% charging capacity, but a relatively high number of days operated in extreme temperature conditions may have its charging capacity degrade at a faster rate than a CMA 270 with a 70% charging capacity and no days operated in extreme temperature conditions. Both CMAs 270 may be suitable for reconditioning and use in their second lives, but the appropriate uses for the two CMAs 270 in their second lives may be different based on their classification resulting from evaluation of their respective useful indicators. Tracking and storage of useful life indicators can also be used to evaluate returned or warrantied battery packs, fix or refurbish battery packs returned within their first life, and improve manufacturing processes by comparing various CMAs 270 to one another.

The useful life indicators are used to identify when a CMA 270 has reached an end of life threshold. The CMA 270 may have multiple end of life thresholds. For example, the CMA 270 may be suitable for use in a first application during the span of its first life (e.g., a commercial lawn mower). When the CMA 270 reaches its first end of life threshold (e.g., 80%, 75%, 70%, etc. of its useful life), the CMA 270 is taken out of service for the first application and returned to the CMA 270 manufacturer. The CMA 270 manufacture then categorizes or classifies the CMA 270 based on its useful life data to identify a suitable second life application for that particular CMA. If necessary, that CMA 270 is reconditioned or refurbished and then combined with other similarly classified CMAs 270 to form a battery pack 100 for use in a second life application. This new battery pack 100 can be used in the second life application until the CMA 270 reaches a second end of life threshold (e.g., 50%, 45%, 40%, etc. of its useful life). This method of using the same CMA 270 for different applications based on the CMA's life cycle allows the CMA 270 manufacturer to take greater advantage of the CMA's available capacity by using the CMA 270 in multiple applications. Instead of having a CMA 270 at the end of its first life discarded and not using the remaining battery capacity of the CMA 270, the CMA 270 may be used in multiple applications. The serviceability of the battery pack 100 with conventional service tools beneficially allows the CMAs 270 to be removed and replaced for second life applications.

The CMA 270 manufacturer may lease battery packs consisting of multiple CMAs 270 to the user of the equipment powered by the battery pack 100. This approach would enable the user of the CMA 270 during its first life to return the battery pack 100 at the end of its first life to the CMA 270 manufacturer, allowing the CMA 270 manufacturer to classify the CMAs 270 and reuse them for second life applications, where the resulting battery packs could again be leased or sold to the user of the equipment powered by the battery pack 100 consisting of CMAs 270 in their second life. Alternatively, the CMA 270 manufacture can sell the battery pack 100 consisting of CMAs 270 and buy back the battery pack 100 at the end of the first life of the CMAs 270 for classification and reuse in a second life application.

The BMS 222 can be configured to identify which CMA 270 in the battery pack 100 is in need of servicing. For example, the BMS 222 may determine which CMA 270 experienced a failure in the battery pack 100. In some embodiments, to determine the faulty CMA, the BMS 222 measures readings of each voltage tap on each CMA 270. For example, the BMS 222 monitors each of the voltage taps 214 on each of the CMAs 270 and determines if the reading on each voltage tap 214 deviates from an expected measurement. The BMS 222 can be configured to trigger a service alarm for a faulty CMA. For example, when monitoring current draw patterns, if a CMA 270 is the first to hit a top voltage level or the first to hit a bottom voltage level (e.g., zero voltage), the BMS 222 identifies the “bad” CMA and triggers a service alarm. The BMS 222 may also monitor which CMA 270 in the battery pack 100 is first to charge or discharge in order to identify a malfunctioning CMA. Advantageously, the battery pack 100 is configured to be serviceable. As such, when a CMA is identified as faulty by the BMS 222, the individual CMA can be swapped out for a functional CMA 270. In some embodiments, the BMS 222 also monitors and stores the temperature of each CMA 270 within the battery pack 100 using data received from a temperature sensor coupled to each CMA 270 (e.g., thermistors 217).

The BMS 222 includes several connectors on one side of the BMS 222. The input and output components of the BMS 222 may be fused to the BMS 222 with resettable fuses. In some embodiments, a BMS cover 224 is positioned surrounding the BMS 222. The BMS cover 224 can provide protection for the BMS 222 and the connectors and connections to various harnesses coupled to the BMS 222. In some embodiments, the BMS cover 224 is a structural potting box that is crush and impact resistant, as well as metal, thermal, and electronic magnetic interference (EMI) resistant. The BMS 222 includes thermistor connectors 226 for monitoring temperature of each of the CMAs 270 of the battery pack 100. The BMS 222 includes CMA voltage connectors 220 to receive data on the operation of the battery cells 202 and CMAs 270 throughout the battery pack 100. In some embodiments, a measurement read at positive voltage tap 232 is communicated to the BMS 222 via the CMA voltage connectors 220. Each connector of the BMS 222 may couple to a connection harness, similar to contactor harness 228 or shunt harness 230.

In some embodiments, the BMS 222 includes a pre-charge circuit and a bleed circuit integrated into the same board of the BMS 222. In some embodiments, the BMS 222 conducts a current profile of the battery pack 100 to detect what components are plugged into the battery pack 100. When an abnormal profile of the battery pack 100 is detected, the BMS 222 may signal an alarm as a notification of the abnormality. In some embodiments, when the battery pack 100 is connected in parallel or series with another battery pack, the BMS 222 writes to the neighboring BMS of the connected battery pack to update the old firmware with the newest firmware. The BMS 222 can also be configured to update a charger, or other energy source, for the battery pack 100 with newer firmware and can receive updates from the charger with newer firmware. In some embodiments, the BMS 222 can operate in three different states, recharge, charge, and hybrid. During the hybrid state, the BMS 222 may effectively charge the battery pack 100 when meant to be discharging, with or without communication. While charging, the BMS 222 may use adaptive charge limits. For example, if receiving regenerative charging, where the charge of battery pack 100 is being topped off, the BMS 222 may lower the top end charge limit to avoid a top end fault due to regenerative charging. The decision of the BMS 222 to lower the top end charge limit may be based on a frequency of fault occurrence. In another example, the BMS 222 may change the top end charge to 4.2 volts to prevent reaching a top end fault, when originally the top end charge was 4.1 volts per CMA 270.

The battery pack 100 is also shown to include CMA-to-CMA interlock 204. The CMA-to-CMA interlock 204 may allow the several CMAs 270 to be mounted in a parallel configuration. An end-of-string mount assembly 212 is also shown in battery pack 100. The end-of-string mount assembly 212 may be used at both ends of a tier of the battery pack 100 to terminate connection when a CMA 270 does not connect to another CMA 270. In some embodiments, the end-of-string mount assembly 212 is coupled to a negative collector plate 254. The negative collector plate 254 can extend outward from one side of the bottom CMA cell holder frame of a CMA 270. In some embodiments, the negative collector plate 254 extends away from an outermost set of pockets of the bottom CMA cell holder frame of the CMA 270 to form a generally planar bottom surface that is coupled to the end-of-string mount assembly 212.

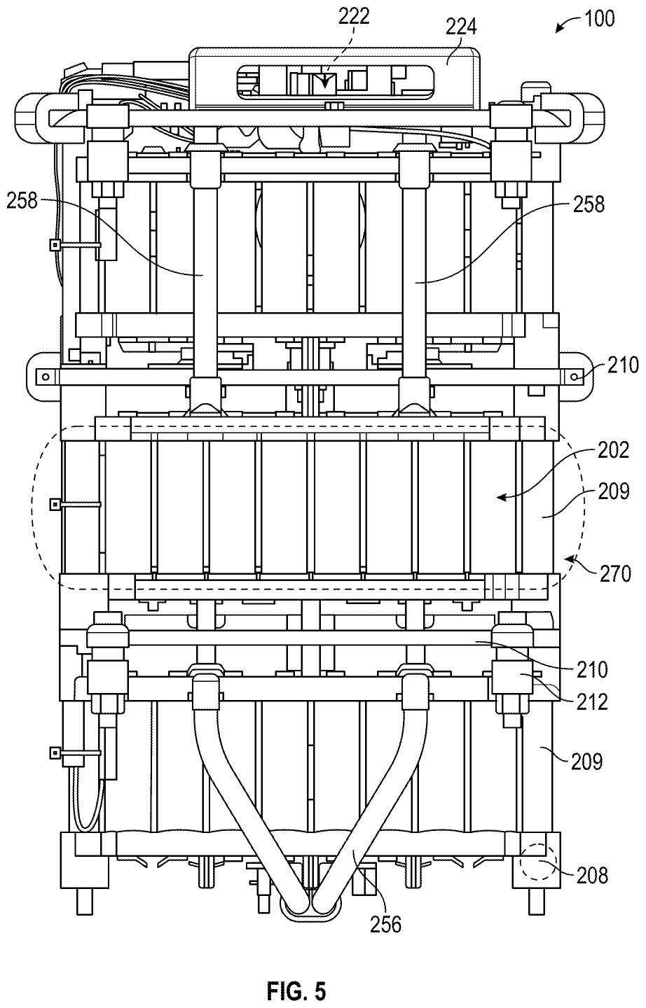

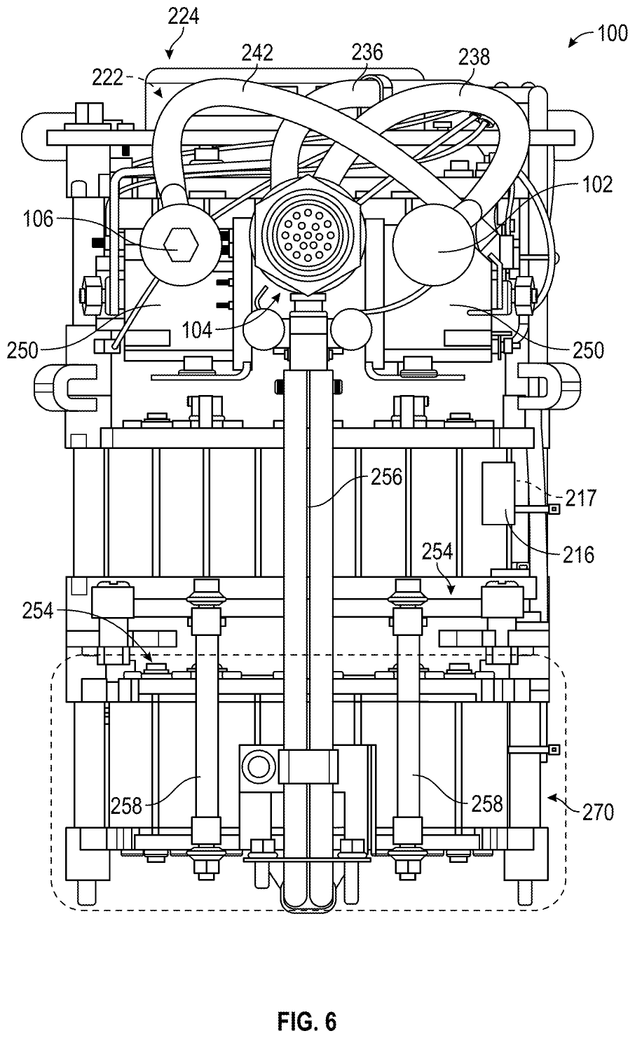

The battery pack 100 is also shown to include a communication harness 236, a negative cable assembly 238, a contactor-to-contactor busbar 240, a positive cable assembly 242, a positive terminal-to-contactor busbar 244, a positive terminal 106, a pass-through data connector 104, a negative terminal 102, battery pack dual contactors 250, contactor coil terminals 252, negative CMA-to-ground cable assembly 256, series tier flexible busbars 258, shunt isolators 262, and CMA cell holder 264. In some embodiments, the communication harness 236 connects the pass-through data connector 104 to the BMS 222. In some embodiments, the pass-through data connector 104 couples to the pass-through data connector 104 on the front panel of the housing 108 for the battery pack 100. The negative CMA-to-ground cable assembly 256 may run underneath the battery pack 100 and up to an end-of-string mount assembly 212, using negative cable routing, from the first CMA 270 block to the ground 272 of the last CMA 270 block. In some embodiments, the negative CMA-to-ground assembly is routed from a first CMA 270 on the top tier of the battery pack 100, down the front side (e.g., as shown in FIG. 6) of the battery pack 100, below a base plate (e.g., as shown in FIG. 4) of the battery pack 100, and up a rear side (e.g., as shown in FIG. 5) of the battery pack 100 to connect to a last CMA 270 on the bottom tier of the battery pack 100. The series tier flexible busbars 258 electrically connect the various tiers of the battery pack 100. In some embodiments, the CMA cell holder 264 is a bottom CMA cell holder frame (e.g., bottom CMA cell holder frame 704 (FIG. 7)) coupled to the negative terminals of the battery cells 202 for each CMA 270.

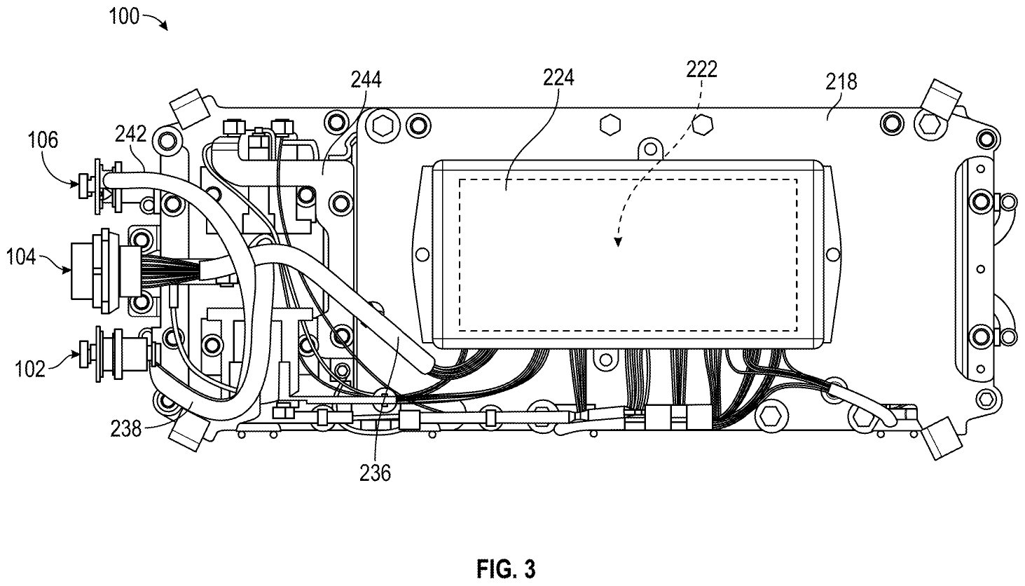

A top view 300 of the battery pack 100 is shown in FIG. 3, according to an exemplary embodiment. The top view 300 is shown to include the positive terminal-to-contactor busbar 244, the positive cable assembly 242, the negative cable assembly 238, the communication harness 236, the positive terminal 106, the pass-through data connector 104, the negative terminal 102, the BMS cover 244, and the top plate 218, among other components of the battery pack 100.

Referring now specifically to FIG. 4, a bottom view 400 of the battery pack 100 is shown, according to an exemplary embodiment. Bottom view 400 is shown to include a base plate 402 and bottom collector plates 404. Each bottom collector plate 404 is coupled to the bottom of each CMA 270 block of the battery pack 100. Bottom view 400 also shows the positive terminal 106, negative terminal 102, pass-through data connector 104, and the negative CMA-to-ground cable assembly 256 running beneath the battery pack 100. In some embodiments, some of the bottom collector plates 404 may be negative collector plates coupled to the negative terminals of the battery cells 202 in a CMA 270. Other bottom collector plates 404 are positive collector plates coupled to the positive terminals of the battery cells 202 in a CMA 270 of the bottom tier of the battery pack 100.

The battery cells 202 in each CMA 270 of the battery pack 100 can be placed in electrical communication with one another using a bottom collector plate (e.g., bottom collector plate 404) and a top collector plate. The collector plates can be formed of an electrically conducting metallic material (e.g., copper, aluminum) that can receive and conduct current through terminals extending away from each battery cell 202. The thickness of the top and bottom collector plates can be selected to carry an amount of current without significant raise in the temperature of the collector plates. The thickness of the collector plates may also give current pass-through point sufficient area at lap joints between plates and torque requirements for clamping plates and spreading out clamp forces. The bolting patterns of the collector plates can allow symmetrical, even flow of current across each CMA. In some embodiments, each of the battery cells 202 includes a positive terminal connected to the top collector plate and a negative terminal connected to the bottom collector plate. Conversely, each of the positive terminals could be connected to the bottom collector plate, while each of the negative terminals could be connected to the top collector plate.

Each of the collector plates can include a series of apertures formed through a generally rectangular base. The number of apertures formed through each collector plate can correspond to the number of battery cells 202 that are present in or that could be present in the CMA 270. The bottom collector plate can be coupled to a bottom CMA cell holder frame 704 (FIG. 7) so that each aperture is positioned below a pocket of the bottom CMA cell holder frame 704. Each aperture can be aligned with (i.e., overlapping to some extent) a terminal hole in the bottom CMA cell holder frame 704. The overlapping orientation can allow a terminal of a battery cell 202 received within the pocket to extend downward through the bottom CMA cell holder frame 704 and the bottom collector plate to make an electrical connection with a bottom surface of the bottom collector plate. Similarly, the top collector plate can be coupled to the top CMA cell holder frame 702 (FIG. 7) so that each aperture is positioned above a pocket of the top CMA cell holder frame 702. Each aperture can also be aligned with a terminal hole in the top CMA cell holder frame 702 so that a terminal of a battery cell 202 received within a pocket can extend through the top CMA cell holder frame 702 and the base of the top collector plate.

The top and bottom collector plates (e.g., the bottom collector plates 404) each have generally complimentary geometry to seat upon the bottom CMA cell holder frame 704 and the top CMA cell holder frame 702. For example, the apertures of top collector plates and bottom collector plates 404 can be defined by a generally elongate oval shape that can be received around locating features of the top CMA cell holder frame 702 and the bottom CMA cell holder frame 704. The shape of the apertures can form a clearance fit around the locating features to help position the top collector plates and bottom collector plates 404 during assembly of the CMA.

Referring now to FIG. 5, a rear view 500 of the battery pack 100 is shown, according to an exemplary embodiment. The rear view 500 shows the BMS 222 inside of the BMS cover 224 and CMAs 270 in the three different tiers of the battery pack 100. The rear view 500 also gives a better perspective view of the connections between the different tiers of the battery pack 100. The series tier flexible busbars 258 are shown connecting the top tier to the middle tier. In between the tiers, the spacers 209 are shown. The spacers 209 may couple the top CMA cell holder frames 702 (FIG. 7) to the bottom CMA cell holder frames 704 (FIG. 7) of each CMA 270 in each tier of the battery pack 100. The rear view 500 also shows the midplates 210 between the tiers of the battery pack 100 and the negative CMA-to-ground cable assembly 256 coupled to one of the end-of-string mount assemblies 212 at ground 272. In some embodiments, the top tier includes four CMAs 270, the middle tier of the battery pack 100 includes five CMAs 270, and the bottom tier includes five CMAs 270. In other embodiments, the battery pack 100 may have more or less than fourteen total CMAs 270.

Each CMA 270 in the battery pack 100 is the same as the others in the battery pack 100 and includes an end connection with an interface to provide up or down routing or terminate, since the “end” CMA 270 does not connect to another CMA 270. The end connection component of each CMA 270 is common to connect to other CMAs 270 of the battery pack 100. In some embodiments, one or more of the CMAs 270 in the battery pack 100 may have the same form factor as a CMA 270 without “power control,” but may also include a contactor, a current sensor (e.g., a shunt resistor), and a BMS controller to manage the power of the CMA 270 “power control” block.

The battery cells 202 of the CMA 270 are depicted. In some embodiments, all thirty-two battery cells 202 are connected in parallel in a 1S32P (one series, thirty-two parallel) arrangement by a single top collector plate (e.g., positive collector plate 266) and a single bottom collector plate (e.g., negative collector plate 254), with all the battery cells 202 pointed in a single direction. In other embodiments, two groups of sixteen battery cells 202 are connected in parallel with the two groups connected in series in a 2S16P (two series, sixteen parallel) arrangement. In some embodiments, the battery cells 202 may be connected in parallel from a 1S16P (one series, sixteen parallel) arrangement, while in other embodiments the battery cells 202 may be connected in a 2S32P (two series, thirty-two parallel) arrangement with a contactor plate change. Top collector plates and bottom collector plates can be used to connect the thirty-two battery cells 202. In some embodiments, each top collector plate and each bottom collector plate can support and connect sixteen battery cells 202 in parallel. The two sets of sixteen battery cells 202 can then be electrically coupled together to place the sets of sixteen battery cells 202 in series with one another. Arranging a relatively large number of battery cells 202 in parallel in this manner helps to slow the degradation of the charge capacity of the CMA 270. In other embodiments, the number of battery cells 202 in the CMA 270 may be greater or fewer and the connection arrangements between the battery cells 202 may vary depending on the ratings needed from a particular CMA 270 (e.g., voltage, capacity, power, etc.). Each battery cell 202 has a positive terminal and a negative terminal.

Referring now to FIG. 6, a front view 600 of the battery pack 100 is shown, according to an exemplary embodiment. The front view 600 shows a better perspective view of the dual contactors 250, the positive terminal 106, the pass-through data connector 104, the negative terminal 102, the positive cable assembly 242, the negative cable assembly 238 and the communication harness 236 specifically. In some embodiments, the dual contactors 250 and the positive terminal 106, the negative terminal 102, and the pass-through data connector 104 are positioned in line with the top tier of the battery pack 100. The front view 600 is also shown to include a closer view of the thermistor tape 216 and thermistor 217 coupled to a battery cell 202 of a CMA 270 in the battery pack 100. In some embodiments, each CMA 270 of the battery pack 100 includes one thermistor 217 in order to monitor the current temperature levels of each CMA 270 throughout the battery pack 100. As such, the variability in temperature throughout the battery pack 100 may be tracked and managed by the BMS 222. The different tiers of the battery pack 100 can also be seen in the front view 600. In some embodiments, the battery pack 100 may have more or less than three tiers of CMAs.

Referring now to FIG. 7, a view 700 is shown of a left side of the battery pack 100 of FIG. 2, according to an exemplary embodiment. The battery cells 202 are supported by a top CMA cell holder frame 704 and a bottom CMA cell holder frame 706. The top CMA cell holder frame 702 and the bottom CMA cell holder frame 704 can each be continuous components formed of insulating polymeric materials. The bottom CMA cell holder frame 704 may include a generally rectangular base including a series of cylindrical protrusions extending upwardly away from the base. The cylindrical protrusions define a series of pockets that can each receive a battery cell 202, for example. Each pocket can include a generally circular base circumscribed by the cylindrical protrusion associated with the pocket. In some embodiments, a terminal hole is formed through the base of the bottom CMA cell holder frame 704. The terminal hole can be approximately centered within the base to allow a terminal of a battery cell 202 to extend through the bottom CMA cell holder frame 704. Alternatively, the terminals may be entirely contained within the pocket, and the terminal holes allows access to the terminals of the battery cells 202. Access to the terminals of the battery cells 202, generally, can be helpful in assembly and/or maintenance processes where wire bonds between the terminals and battery cells 202 are being created or repaired. Windows can be formed in the base and/or the cylindrical protrusions to define adhesive flow paths through the bottom CMA cell holder frame 704 onto the battery cells 202 positioned within the pockets of the bottom CMA cell holder frame 704. A curable adhesive may be used to ensure robust coupling between the battery cells 202 and the bottom CMA cell holder frame 704. Additionally, the curable adhesive may be used to couple the bottom collector plates (e.g., negative collector plate 254) to the bottom CMA cell holder frames 704.

The top CMA cell holder frame 702 can include many of the same features present in the bottom CMA cell holder frame 704. Because the top CMA cell holder frame 702 may be a substantial mirror image of the bottom CMA cell holder frame 704 in some embodiments, components present in the top CMA cell holder frame 702 having common names in both the bottom CMA cell holder frame 704 and the top CMA cell holder frame 702 should be considered to have the same or substantially similar geometries, orientations, structures, or relationships to other components as described with reference to the bottom CMA cell holder frame 704. The top CMA cell holder frame 702 also includes a generally rectangular base. A series of cylindrical protrusions may extend upwardly away from the base to define another series of pockets that can each receive a battery cell 202. Each pocket can include a generally circular base circumscribed by the cylindrical protrusion associated with the pocket. A terminal hole can be formed through the base. Windows can be formed in the base and/or the cylindrical protrusions to define adhesive flow paths through the top CMA cell holder frame 704 onto the battery cells 202 positioned within the pockets. The top surface of the top CMA cell holder frame 702 may include recesses formed into the top CMA cell holder frame 702 to define adhesive flow paths. The recesses can direct curable adhesive around battery cells 202 during the CMA 270 assembly process, which can help create a robust coupling between battery cells 202 and the top CMA cell holder frame 702. Furthermore, the curable adhesive may be used to couple the top collector plates (e.g., positive collector plate 266) to the top CMA cell holder frames 702.

In some embodiments, the CMAs 270 may be scaled to adjust to change in lengths and diameters of the battery cells 202 used for the CMAs 270. The top CMA cell holder frame 702 and the bottom CMA cell holder frame 704 may be varying lengths depending on the number of cells used in the CMAs 270 and the type of battery cells 202 used for each CMA 270. For example, the pockets of the top CMA cell holder frame 702 and the bottom CMA cell holder frame 704 may vary in cylindrical cell form factors depending on the diameters of the battery cells 202 utilized in the battery pack 100. The battery pack 100 may also be assembled to use longer or shorter battery cells 202, in which case the top CMA cell holder frame 702 and the bottom CMA cell holder frame 704 may be closer together in height or father apart in height. In some embodiments, when battery cells 202 have a different diameter, the same mounting points (e.g., bolt patterns) for each CMA 270 is used for the construction of the CMAs 270, but the top CMA cell holder frame 702 and the bottom CMA cell holder frame 704 have altered pocket sizes to accept the different battery cells 202.

The spacers 209 can be defined by a height (i.e., a longitudinal length) that is larger than a height of each battery cell 202. By being taller than the battery cells 202, compressive loading experienced by either of the top CMA cell holder frame 702 or the bottom CMA cell holder frame 704 is initially diverted to the spacers 209, which engage the collars of the frames. The spacers 209 keep the bottom CMA cell holder frame 704 and the top CMA cell holder frame 702 at a fixed distance apart from one another, which prevents the top CMA cell holder frame 702 and the bottom CMA cell holder frame 704 from applying extreme or otherwise unwanted compressive stress to each battery cell 202 that could be caused by loading from another CMA 270 positioned in a tier of the battery pack 100 above the CMA 270, for example.

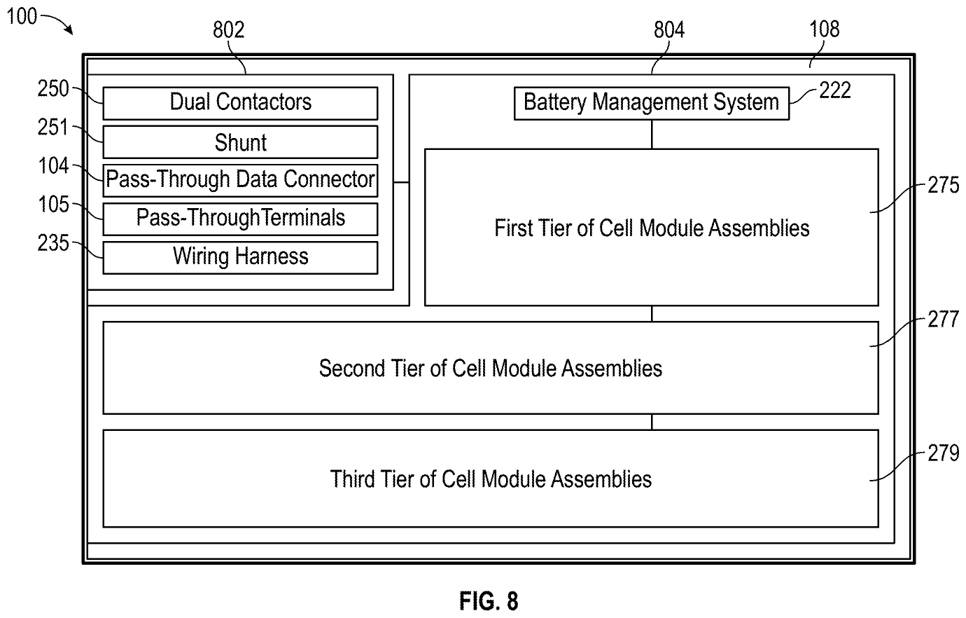

Referring now to FIG. 8, a block diagram of the battery pack 100 depicts various serviceability compartments of the battery pack, according to some embodiments. The battery pack 100 includes the housing 108, as depicted in FIG. 1. In some embodiments, the housing 108 is made up of exterior side plates, a base plate, and a cover to protect the internal components of the battery pack 100. In some embodiments, the housing 108 includes a first compartment 802 and a second compartment 804 within the housing 108. The first compartment 802 can receive and house several components. For example, the first compartment 802 can include dual contactors 250, a shunt 251, the pass-through data connector 104, the pass-through terminals 105, and the wiring harness 235. In some embodiments, the wiring harness 235 includes a group of wiring harnesses for various different controls and communications of the battery pack 100. For example, the wiring harness 235 can include a shunt harness 230, a communication harness 236, a contactor harness 228, etc. The wiring harness 235 may integrate the power wiring and the temperature wiring for the battery pack 100 into a single harness. Thus, if the wiring comes loose or if the wiring is crimped, the entire wiring harness 235 can easily be changed out and replaced when servicing the battery pack 100. The first compartment 802 may include an aperture for the wiring harness 235 to pass-through the first compartment 802 to connect with the components within other compartments (e.g., the second compartment 804), such as the BMS 222.

In some embodiments, the first compartment 802 may include one or more panels and/or ports that physically and electrically couple to one or more other compartments in the battery pack 100. The pass-through data connector 104 and pass-through terminals 105, including negative terminal 102 and positive terminal 106, are accessible from the exterior of the housing 108. As such, the pass-through data connector 104 and pass-through terminals 105 “pass-through” a front panel 803 (e.g., a panel covering the front view 600 of FIG. 6) of the battery pack 100. Accordingly, the pass-through data connector 104 and the pass-through terminals 105 can be accessed by a user servicing the battery pack 100 to run a diagnostic analysis of the battery pack 100 and/or to update firmware of the battery pack 100 externally. The interior of the first compartment 802 can be accessed by removing the front panel 803, which can be mounted to the housing 108 using a series of fasteners 805, for example. In some embodiments, the fasteners 805 can be standard screws (e.g., Phillips head, flat head, etc.) that can be readily removed using standard tools. In some embodiments, the fasteners 805 are tamper-proof screws that need specialized and/or non-standard tooling to remove. Tamper proof screws can includes screws having snake eyes interfaces, torx interfaces, triangular recess interfaced, reverse threads, or a one-way slotted interface, for example. Accordingly, unpermitted access into the battery housing 108 and first compartment 802 is restricted. Maintenance can still be performed by personnel with the appropriate tooling, such that the serviceability of the components mounted to the front panel 803 and the components positioned within the first compartment 802 is not drastically reduced. In some examples, owners of the battery (e.g., a rental company, an OEM, etc.) can select which type of fastener 805 is used to secure the front panel 803 to the housing 108, thereby controlling the type and amount of access available to different users of the battery pack 100. In some examples, more sophisticated users can be supplied with battery packs 100 having standard screws 805, while battery packs 100 provided to less sophisticated users can be exchanged with the one or more types of tamper-proof screws.

The second compartment 804 includes the BMS 222, a first tier of CMAs 275, a second tier of CMAs 277, and a third tier of CMAs 279, positioned as shown in FIG. 7, for example. There may be more or fewer CMAs or tiers of CMAs. Each tier of CMAs 275, 277, 279 may include several CMAs 270 physically and electrically connected. The first tier of CMAs 275 is positioned above the second tier of CMAs 277, and the second tier of CMAs 277 is positioned above the third tier of CMAs 279. As such, to service a CMA 270 in the third tier of CMAs 279, a user first disconnects the first tier of CMAs 275, then the second tier of CMAs 277 to build down to the bottom, third tier of CMAs 279. In other embodiments, the tiers of the battery packs 100 may be slid into and out of place to remove a tier including each of its parallel components after disconnecting the wiring of the respective tier. In some embodiments, a long rod may be threaded through the first tier of CMAs 275 to the third tier of CMAs 279. Therefore, the structure of the battery pack 100 may be decompressed while servicing a CMA 270 within the second compartment 804. The first tier of CMAs 275 is positioned proximate the top plate of the housing 108. The BMS 222 may be positioned on a top surface of the first tier of CMAs 275. In other embodiments, the BMS 222 is positioned elsewhere in the second compartment 804 for greater protection to the BMS 222 and/or to reduce the amount of wiring required to connect the BMS 222 to the electrical components within the first compartment 802. Despite the BMS 222 being positioned within the second compartment 804, the BMS 222 can be accessed from a first level of serviceability, outside the housing 108 of the battery pack 100 via the pass-through data connector 104. Thus, the BMS 222 can be accessed from a first level of serviceability to update the firmware programmed for the battery pack 100 and/or to run diagnostics on which components of the battery pack 100 are functional. In other embodiments, the BMS 222 is accessed to reprogram the BMS 222 for a second life application of the battery pack 100. In some embodiments, there may be more or less tiers of CMAs than shown in the block diagram of battery pack 100 of FIG. 8. In some embodiments, the components of the second compartment 804 include core battery cells of the battery pack 100.

The second compartment 804 can include an external access point into the second compartment 804 that is separate and independent from the first compartment 802. For example, and as depicted in FIG. 1, the housing 108 can include a top panel 807. The top panel 807 extends across the top of the battery pack 100, above the BMS 222 and the tiers of CMAs to form a roof of the battery pack 100. The top panel 807 is movably coupled to the housing 108 to provide selective access into the second compartment 804. In some examples, the top panel 807 includes a locking mechanism 809 that requires an individualized or customized key to access. When the locking mechanism 809 is unlocked, the top panel 807 can swing upward, uncovering the BMS 222 and opening the second compartment 804. In some examples, the top panel 807 is hingedly coupled to the housing 108 opposite the locking mechanism 809. In still other examples, locking mechanism 809 are positioned on each end of the top panel 807, which can further improve security into the battery pack 100. Although shown as a mechanical lock, various other types of locking mechanisms 809 can be incorporated as well. For example, an RFID reader can be incorporated into the battery pack 100, which releases and/or unlocks the locking mechanism 809 upon detecting that a suitable key is within range. In still other embodiments, a Bluetooth-based locking mechanism 809 is installed into the housing 108. In some embodiments, a keypad is positioned on the housing 108 and can unlock the locking mechanism 809 in response to receiving a correct access code. In still further embodiments, unlocking the locking mechanism 809 can release a side panel 811, which permits access to the lower tiers of CMAs within the battery housing.

The battery pack 100 may require service during its lifetime. Varying levels of serviceability are provided for an operator to access different components of the battery pack 100. Accordingly, each compartment of the battery pack 100 has a different serviceability level. The different serviceability levels can be based upon the necessary authorization needed to access the battery pack 100. As such, components located within separate compartments may have different serviceability levels. As described herein, components having the same level of serviceability refers to components being accessible for servicing without the operator needing to bypass additional securing mechanisms or other security to access the components. For example, components accessible from the outside of the battery pack 100 have a higher level of serviceability than components in the first compartment 802, nested within the housing of the battery pack 100. In some embodiments, a lower level of serviceability is associated with a compartment nested within another compartment with a higher level of serviceability. For example, components in the first compartment 802 of the battery pack 100 have a higher level of serviceability than components in the second compartment 804 of the battery pack 100. An operator may access and service the components in the first compartment 802 before gaining access to components in the second compartment 804 by bypassing a securing mechanism. As such, the operator may then service the components in the second compartment 804 with the lower level of serviceability.

The battery pack 100 has a first level of serviceability. This first level of serviceability may include cosmetics and diagnostics of the battery pack 100. Cosmetic components of the battery pack 100 can include the exterior components of the battery pack 100. For example, a first level of serviceability includes repairing any cracks or breaks in the external housing 108, such as a side plate of the housing 108 shown in FIG. 1. The first level of serviceability may be accessed without requiring a user to remove the housing 108 of the battery pack 100 to service internal components of the battery pack 100. The second level of serviceability can include components within the first compartment 802 inside the housing 108. The second level of serviceability may include electrical components, such as the dual contactors 250 and BMS 222. A third level of serviceability can include components within the second compartment 804, nested inside the housing 108. The third level of serviceability may include tiers of CMAs 270. In some embodiments, the third level of serviceability includes battery cells 202 configured in other arrangements than as shown in the CMAs 270. The serviceability level of the components in the first compartment 802 are higher than the serviceability level of the components in the second compartment 804. For example, the components in the first compartment 802 are easier to service than the components of the second compartment 804. The components of the second compartment 804 may not be accessed without first accessing the first compartment 802 and/or without first bypassing additional securing mechanisms that are not used to access the components in the first compartment 802.

Each compartment located within the housing 108 of the battery pack 100 may have a different access point and a different level of access. For example, the first compartment 802 has a first access point (e.g., the panel 803) with a securing mechanism (e.g., the fasteners 805) and the second compartment 804 has a second access point (e.g., the top panel 807) with a second securing mechanism (e.g., the locking mechanism 809). In some embodiments, the access point of the second compartment 804 is more internal (e.g., further from the housing 108, nearer the center of the battery pack 100, formed through a wall of the first compartment 802, etc.) than the first access point of the first compartment 802, which can be the front panel 803. In some embodiments, the first compartment 802 is accessible by a first securing mechanism having a first level of security. As depicted in FIG. 1, the first securing mechanism can be the panel 803 and fasteners 805 which secure the panel 803 to the housing 108. The second compartment 804 may be accessible by a second securing mechanism with a second level of security. The second securing mechanism can be the top panel 807 and the locking mechanism 809. The second level of security of the securing mechanism for the second compartment 804 may be a higher level of security than the first level of security of the securing mechanism for the first compartment 802. For example, a more complex tool (e.g., a customized key, biometric access, RFID key, etc.) may be needed to unlock the second securing mechanism to access the second compartment 804 than is needed to access the first compartment. After accessing the first compartment 802, a user may need to unlock more complex securing mechanisms in order to access the second compartment 804 for servicing. In some examples, the second compartment 804 is only accessible through the first compartment 802. In other embodiments, the securing mechanisms may be the same for both the first compartment 802 and the second compartment 804. However, it may be more difficult to reach the access point for the second compartment 804, because the second compartment 804 is further insulated within the battery pack 100. The different access levels of the battery pack 100 can be defined by the securement mechanisms. Common fasteners 805 that can be removed or installed with common tools (e.g., a Phillips screwdriver, a flat head screwdriver, etc.) can be considered to provide a first level of access. Tamper proof fasteners (e.g., fasteners that require customized or uncommon tools) can be considered to provide a second level of access that is lower than the first level of access. In still further examples, locking mechanisms (e.g., locks 809 that require a physical or digital key) can be considered to provide a third level of access that is still lower than the second level of access. For purposes of this disclosure, the term “lower level of access” means that it is less accessible and/or more difficult to access. Similarly, a “higher level of access” refers to something that is more accessible and/or easier to access. Accordingly, the battery is arranged so that the first compartment 802 is easier to access (e.g., has a first, higher level of access), and includes components that are more likely to need service, than the second compartment 804, which is more difficult to access (e.g., has a second, lower level of access) because it includes a more sophisticated locking or securing mechanism.

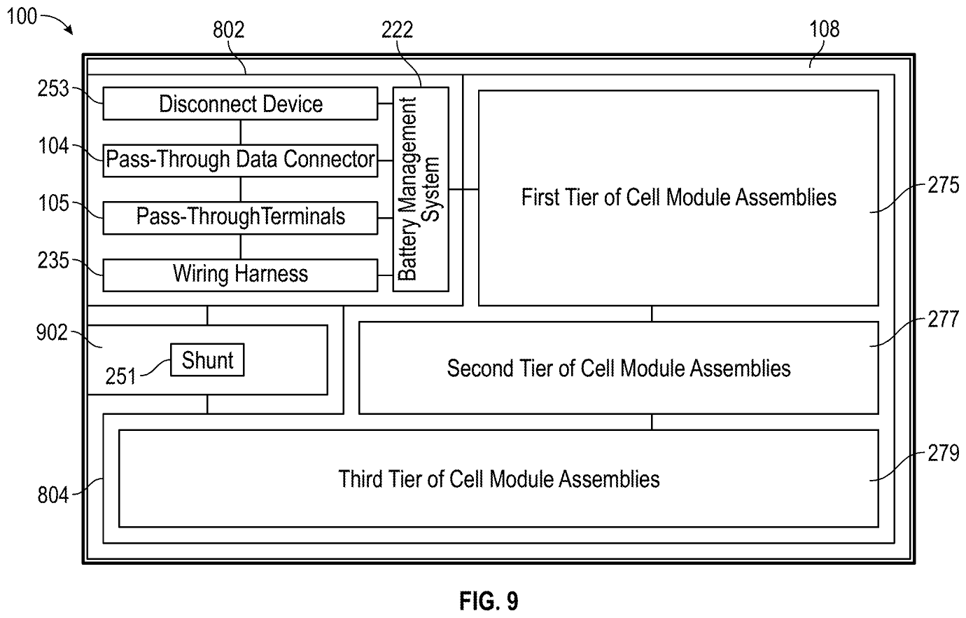

Turning now to FIG. 9, a block diagram of the compartments of battery pack 100 is shown, according to some embodiments. The first compartment 802 may include at least the BMS 222, a disconnect device 253, the pass-through data connector 104, the pass-through terminals 105, and the wiring harness 235. The BMS 222 can be accessed from the exterior housing 108 of the battery pack 100 via the pass-through data connector 104. Therefore, a user can connect a diagnostics tool to the pass-through data connector 104 to access information on the battery pack 100. For example, the user may access information from the BMS 222 regarding the diagnostics of which components of the battery pack 100 are functional or require servicing. Each connection exposed while accessing the first compartment 802 may be fail safe to prevent harm to overall functionality of the battery pack 100. In some embodiments, the BMS 222 includes a single, press-fit connector with power buds to prevent exposing any live connections in the first compartment 802. The BMS 222 may be connected to a loop outside of the disconnect device 253 to prevent the BMS 222 from sending voltage (e.g., 12V) to the disconnect device 253 if the wiring cable of the pass-through data connector 104 becomes disconnected. In some embodiments, the disconnect device 253 is a single contactor. In other embodiments, the disconnect device 235 includes dual contactors 250. It is also contemplated that the disconnect device 253 may be an alternative means of disconnect, such as a metal-oxide-semiconductor field-effect transistor (MOSFET) board.

In some embodiments, the components within the first compartment 802 may be integrated into a block that is the same or similar as each of the blocks of CMAs 270. For example, all of the components of the first compartment 802 may be built-into a “controls” block with the same form factor as the form factor of the blocks of CMAs 270 within the second compartment 804. In some embodiments, this “controls” block module component, structured similar to the module blocks of CMAs 270, includes the BMS 222, disconnect device 253 (e.g., dual contactors 250), and the shunt 251. This “controls” block module component may have the same form factor as the blocks of CMAs 270 in order to bolt the “controls” block, module component easily into place during construction of the battery pack 100. By including these components of the battery pack 100 in a single module similar to the blocks of CMAs 270, it may be much simpler to replace the logic components if one of them fails. In another embodiment, the disconnect device 253 may be integrated into a single module with power buds, such that there are no live connections that are unprotected in the module with the disconnect device 253. In some embodiments, a module component with the disconnect device 253 may include an outlet to couple to the first compartment 802 for simplified access to service the disconnect device 253. In some embodiments, the disconnect device 253 may have other receptacles to allow easy removal of the connection in order to service the power connections (e.g., 12V, GNDA, GNDB) of the battery pack 100.

The block diagram of FIG. 9 further shows the second compartment 804 including the first tier of CMAs 275, the second tier of CMAs 277, and the third tier of CMAs 279. As such, the first compartment 802 and the second compartment 804 isolate the several blocks of CMAs 270 from the BMS 222 and the disconnect device 253. Beneficially, the separation of these components in different compartments may make it more difficult for an unexperienced user to access the CMAs 270. For example, after accessing the first compartment 802 while servicing the battery pack 100, a user may have to unlock and/or disconnect a securing mechanism that prevents access to the second compartment 804. In some embodiments, the securing mechanism between the first compartment 802 and the second compartment 804 may include security screws (e.g., tamper proof screws, etc.) and/or other protective measures (e.g., tamper-proof security mechanisms, tape, labels, etc.) in order to access the CMAs 270 positioned within the second compartment 804. On the other hand, the first compartment 802 may easily be accessed after removal of the housing 108 of the battery pack 100. In some embodiments, the second compartment 804 may also include the third compartment 902, positioned proximate the bottom of the battery pack 100 and insulated by the third tier of CMAs 279. Each compartment of the battery pack 100 is electrically and communicably connected with the other compartments via the power and communications wiring of the battery pack 100.

In some embodiments, the shunt 251 is positioned in a third compartment 902. In some embodiments, the third compartment 902 is positioned in a separate compartment from both the first compartment 802 and the second compartment 804. By positioning the shunt 251 in a separate compartment from the first compartment 802, the disconnect device 253 and the shunt 251 are separated. Therefore, positive and negative components of the battery pack 100 are separated and the risk of a short circuit while servicing the battery pack 100 can be further reduced. For example, a wrench could short circuit the battery pack 100 if the wrench were to connect the shunt 251 to the positive busbar (e.g., positive terminal-to-contactor busbar 244), bypassing the disconnect device 253. By placing the shunt 251 outside of the first compartment 802, this possibility is eliminated while servicing the components within the first compartment 802. Furthermore, the shunt 251 may be a component that does not require servicing as often as other components of the battery pack 100 (e.g., disconnect device 253, BMS 222, wiring harness 235, etc.). As such, it may be uncommon for the need to access the more insulated, third compartment 902 in order to service the shunt 251. In some embodiments, the shunt 251 is positioned in a third compartment 902 proximate a bottom side of the battery pack 100. In some embodiments, the shunt 251 is used as a fuse for the battery pack 100 in a fuse panel proximate the bottom side of the third tier of CMAs 279. In other embodiments, the shunt 251 may be positioned proximate a back side (e.g., within the rear view 500 of FIG. 5) of the battery pack 100 to use as a fuse.

In other embodiments, the first compartment 802 may include fewer components than is shown in the block diagram of FIG. 9. Further, in additional embodiments, the first compartment 802 may include additional components not shown in the block diagram of FIG. 9. In some embodiments, the components may be otherwise positioned within the battery pack 100. For example, the shunt 251 may instead be positioned in the first compartment 802, along with the disconnect device 253, BMS 222, terminals 105, data connector 104, and wiring harness 235, rather than the third compartment 902. By using a compartmentalized battery pack 100, the process of servicing the battery pack 100 can be simplified and improved. In some embodiments, the components within the first compartment 802 are more likely to fail than the components within the second compartment 804 and the third compartment 902, which may rarely fail. For example, the contactors of the BMS 222 may be more likely to fail than the CMAs 270 within the second compartment 804. Additionally, by positioning components that may be more likely to fail in a first compartment 802, with an easier, higher level of serviceability than components in a second compartment 804 and/or a third compartment 902, the battery pack 100 can be serviced more quickly. The risk of fracturing the wiring of the battery pack 100 may also be reduced by compartmentalizing the battery pack 100 into at least a first compartment 802 and a second compartment 804.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

The construction and arrangements of the present disclosure, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

1-29. (canceled)

30. A battery pack, comprising:
a housing including a first compartment and a second compartment;
a positive terminal and a negative terminal, the positive terminal and the negative terminal each externally accessible from the housing and extending into the first compartment; and
a plurality of cell module assemblies (CMAs) received within the second compartment, the plurality of CMAs being electrically coupled to the positive terminal and the negative terminal through a connection extending from the second compartment into the first compartment, wherein the plurality of CMAs each include a plurality of rechargeable lithium-ion battery cells;
wherein the first compartment is accessible through a first panel that is movably coupled to the housing through a first securing mechanism providing a first level of access; and
wherein the second compartment is accessible through a second panel that is movably coupled to the housing through a second securing mechanism providing a second level of access, wherein the second securing mechanism is different from the first securing mechanism.

31. The battery pack of claim 30, wherein the first panel is a front panel of the battery pack, and wherein the first panel supports the positive terminal and the negative terminal.

32. The battery pack of claim 31, wherein the front panel further comprises a data connector, the data connector including a connection extending through the first compartment to a battery management system positioned in the second compartment.

33. The battery pack of claim 31, wherein the front panel further comprises a data connector, the data connector including a connection extending into the first compartment to a battery management system positioned within the first compartment, wherein the battery management system is in communication with at least one of the plurality of CMAs within the second compartment.

34. The battery pack of claim 30, wherein the second securing mechanism includes a lock that is selectively unlockable using a key.

35. The battery pack of claim 34, wherein the key is transmitted wirelessly to a reader positioned within the battery pack.

36. The battery pack of claim 30, wherein the first compartment includes a disconnect device, wherein the disconnect device is configured to selectively decouple the plurality of CMAs from the positive terminal and the negative terminal.

37. The battery pack of claim 30, wherein each of a battery management system, a disconnect device, a wiring harness, a shunt, and a data connector are positioned within the first compartment.

38. The battery pack of claim 30, wherein the housing includes a third compartment, wherein a shunt of the battery pack is located in the third compartment.

39. The battery pack of claim 30, wherein the first compartment and the second compartment isolate a plurality of CMAs from a battery management system and a disconnect device within the battery pack.

40. The battery pack of claim 30, wherein the second securing mechanism is only accessible from within the first compartment.

41. The battery pack of claim 30, wherein the first securing mechanism operates independently of the second securing mechanism.

42. The battery pack of claim 30, wherein the first securing mechanism includes a front panel mounted to the housing and wherein the second securing mechanism includes a top panel mounted to the housing.

43. The battery pack of claim 30, wherein each of the plurality of CMAs include a first form factor, wherein a module component comprising a battery management system and a disconnect device of the battery pack has a second form factor, and wherein the second form factor is the same as the first form factor.

44. A battery pack, comprising:
a housing including a first compartment and a second compartment;
a positive terminal and a negative terminal, the positive terminal and the negative terminal each externally accessible from the housing and extending into the first compartment; and
a plurality of cell module assemblies (CMAs) received within the second compartment, the plurality of CMAs being electrically coupled to the positive terminal and the negative terminal through a connection extending from the second compartment into the first compartment, wherein the plurality of CMAs each include a plurality of rechargeable lithium-ion battery cells;
wherein the first compartment is accessible through a first panel that is movably coupled to the housing through a first securing mechanism providing a first level of access; and
wherein the second compartment is accessible through a second panel that is movably coupled to the housing through a second securing mechanism providing a second level of access, wherein the second level of access is lower than the first level of access.

45. The battery pack of claim 44, wherein the first compartment is accessible through the first panel, the first panel being fastened to the housing, and wherein the first panel supports the positive terminal and the negative terminal.

46. The battery pack of claim 45, wherein the first panel further supports a data connector, wherein the data connector is in communication with a battery management system positioned within the housing.

47. The battery pack of claim 46, wherein the battery management system is positioned within the first compartment.

48. The battery pack of claim 46, wherein the battery management system is positioned within the second compartment, and wherein a wired connection extends between the data connector, through the first compartment, and into the second compartment.

49. A battery pack, comprising:
a housing including a first compartment and a second compartment;
a positive terminal, a negative terminal and a data connector terminal, the positive terminal, the negative terminal, and the data connector terminal each externally accessible from the housing and extending into the first compartment;
a plurality of cell module assemblies (CMAs) received within the second compartment, the plurality of CMAs being electrically coupled to the positive terminal and the negative terminal through a physical connection extending from the second compartment into the first compartment, wherein the plurality of CMAs each include a plurality of rechargeable lithium-ion battery cells; and
a battery management system positioned within the housing and coupled to the data connector terminal, wherein the battery management system is configured to communicate externally through the data connector terminal;
wherein the first compartment is accessible through a first securing mechanism providing a first level of access; and
wherein the second compartment is accessible through a second securing mechanism providing a second level of access, wherein the second level of access is lower than the first level of access.
